(19) United States
(12) Patent Application Publication
(10) Pub. No.: US 2003/0159049 A1
(43) Pub. Date: Aug. 21, 2003

(54) Copy-protection by alteration of control signals

(75) Inventors: Jeff Bennett, Spring Valley, NY (US); Michael A. Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/197,340

(22) Filed: Jul. 17, 2002

Related U.S. Application Data
(60) Provisional application No. 60/359,051, filed on Feb. 21, 2002.

(51) Int. Cl. H04K 1/00

(52) U.S. Cl. 713/182

(57) ABSTRACT

A method and system modifies one or more control signals that are associated with the transmission or reception of copy-protected material. By modifying the control signals, most communication devices that rely on the protocol will prevent the transmission of the message, or will prevent or inhibit the subsequent processing or relaying of a received message. For example, if a cyclic-redundancy-code (CRC) is modified, a conventional network device that uses the received-but-modified CRC will likely reject the received material, thereby preventing it from being processed or transmitted further through the network. Select devices are configured to recognize and undo the modification, thereby allowing the material to be further processed. If the material is to be relayed, the modification is reapplied. Preferably, only local-area network devices are configured to undo the modification, while devices that provide wide-area network access are not configured to undo the modification. In this manner, protected content material with modified control signals is likely to be prevented from wide-area network distribution.

This application claims the benefit of U.S. Provisional Patent Application No. 60/359,051, filed Feb. 21, 2002, Attorney Docket US020055P.

### BACKGROUND OF THE INVENTION

1. Field of the Invention

This invention relates to the field of copy protection systems, and in particular to a system that is intended to prevent wide-scale distribution of protected content material. The invention can also be used to limit the routing of protected messages in a network environment.

2. Description of Related Art

With the advent of relatively inexpensive means of reproducing and distributing digitally recorded material, the protection of copy-protected material, such as recordings of artistic performances, has become of primary importance to the holders of the rights to copy the material. Conversely, purchasers of copy-protected material expect to be able to freely copy the purchased material for their own use.

It has become a common practice for many purchasers of content material to make the content material widely available to others, thereby depriving the holder of the rights to copy the material from substantial revenues. This practice of wide-scale distribution of copy-protected material has been substantially facilitated by such systems as Napster, Kaza, Gnutella, and so on, that allow users to widely advertise the availability of the content material, and to freely obtain copies of the available material.

A variety of systems and methods have been proposed for the protection of copy-protected content material, typically via the use of encryption. Some or all of the content material, or ancillary material that is necessary to access the content material, is encrypted. Authorized recipients of the material are provided means for decrypting the encrypted material, while unauthorized recipients are unable to decrypt the encrypted material without a substantial investment of time or materials. As long as the cost of an unauthorized decryption exceeds the benefits that are derivable from the unauthorized decryption, the copy-protected material will generally remain protected.

The cost of providing the aforementioned protection, however, can be substantial. Timely decryption by authorized users often requires a substantial amount of processing power, thereby increasing the cost of consumer electronic devices that are designed to comply with the copy-protection scheme. Similarly, the processes used to manage the distribution and control of the keys that are used to enable only authorized recipients to decrypt the material can be expected to introduce additional infrastructure overhead and complexity, the cost of which will be passed to the consumers. In like manner, the overhead associated with the encryption of messages for communications within a network environment, such as maintaining lists of public keys for encrypting messages to each intended recipient, often makes the “routine” use of encryption for each message inconvenient, if not impractical.

The complexities of conventional copy-protection schemes that are based on encryption also introduce an increased risk of failure. Of particular concern is the failure of the decryption process for authorized use. Consumers will not tolerate protection schemes that erroneously prevent their authorized use of purchased content material, and the likelihood of such erroneous behavior can be expected to be highly dependent upon the degree of complexity of the protection scheme. Holders of the rights to copy the protected material are generally in the business of selling copies of the protected material, and it is generally recognized that an unreliable system for providing authorized access will have a substantially detrimental effect on sales.

### BRIEF SUMMARY OF THE INVENTION

It is an object of this invention to provide a method and system for protecting copy-protected content material from wide-scale distribution. It is a further object of this invention to provide this method and system at a minimal cost. It is a further object of this invention to minimize the complexity of protecting copy-protected content material from wide-scale distribution.

These objects and others are achieved by providing a method and system that modifies one or more control signals that are associated with the transmission or reception of copy-protected material. Most commonly used communication protocols include control signals that regulate the transmission or reception of messages. By modifying the control signals, most communication devices that rely on the protocol will prevent the transmission of the message, or will prevent or inhibit the subsequent processing or relaying of a received message. For example, if a cyclic-redundancy-code (CRC) is modified, a conventional network device that uses the received-but-modified CRC will likely reject the received material, thereby preventing it from being processed or transmitted further through the network. Select devices are configured to recognize and undo the modification, thereby allowing the material to be further processed. If the material is to be relayed, the modification is reapplied. Preferably, only local-area network devices are configured to undo the modification, while devices that provide wide-area network access are not configured to undo the modification. In this manner, protected content material with modified control signals is likely to be prevented from wide-area network distribution.

### BRIEF DESCRIPTION OF THE DRAWINGS

The invention is explained in further detail, and by way of example, with reference to the accompanying drawings wherein:

FIG. 1 illustrates an example block diagram of a copy-protection transmitting system in accordance with this invention.

FIG. 2 illustrates an example block diagram of a copy-protection receiving system in accordance with this invention.

Throughout the drawings, the same reference numerals indicate similar or corresponding features or functions.

### DETAILED DESCRIPTION OF THE INVENTION

Copending US patent application “COPY-PROTECTION BY PRESERVING COPY-CONTROL SIGNALS”, U.S. Ser. No. ______, filed ______ for Michael Epstein, Attorney Docket US020054, discloses a system and method for protecting copy-protected material by providing a copy-control signal that identifies unencrypted material as being copy-protected, and is incorporated by reference herein. A compliant device is configured to enforce appropriate copy-protection safeguards based on the presence or absence of this copy-protection signal. If a compliant device produces a copy of the copy-protected material, the compliant device is configured to assure that the copy-protection signal is contained within the produced copy. To prevent wide-scale distribution of copy-protected material, compliant devices are configured to prevent communication of the copy-protected material to wide-area networks, such as the Internet. Because the compliant devices are configured to maintain the copy-protection signal, and to control the distribution of material that contains this signal, the “innocent” wide-scale distribution of protected content material is avoided. That is, most users of compliant devices are not expected to purposely modify the device to overcome the wide-scale distribution protection that is provided by the invention of the copending application, and therefore a substantial reduction in wide-scale distribution can be expected, without the cost and complexities associated with encryption and decryption systems. Because the protection provided is limited to preventing wide-scale distribution, adverse consumer reactions to the imposed use of a copy-protection scheme are minimized.

This invention and the referenced copending application are premised on the observation that most purchasers of copy-protected content material do not purchase the material with the specific intent of widely distributing the protected material. Furthermore, most purchasers of copy-protected content material do not have strong feelings, one way of the other, concerning copy-protection rights. Typical purchasers desire unlimited rights to copy the material for their personal use, but their decision to purchase the material will not be affected by a limitation in their ability to widely distribute the purchased material. As such, a system that is configured to prevent transmission of content material to a wide-area network, while allowing unrestricted flow within a local network of compliant devices should meet with little consumer resistance.

The copending application relies upon the addition of a copy-protection signal to the protected material, and relies upon compliant devices enforcing the copy-protection rules. It does not, however, address the fact that conventional non-compliant devices that are unaware of this copy-protection strategy will freely transmit the protected material to wide-area networks.

In accordance with this invention, the copy-protection is effected by a modification to one or more control signals that are associated with the protected material. Preferably, the modification to the one or more control signals is designed to hinder the communication of the protected material by most conventional communication or processing devices. In this manner, because the modification to the control signal(s) hinders the communication of the material by conventional communication devices, the likelihood of protected material being propagated by a wide-area communication network, such as the Internet, is substantially reduced.

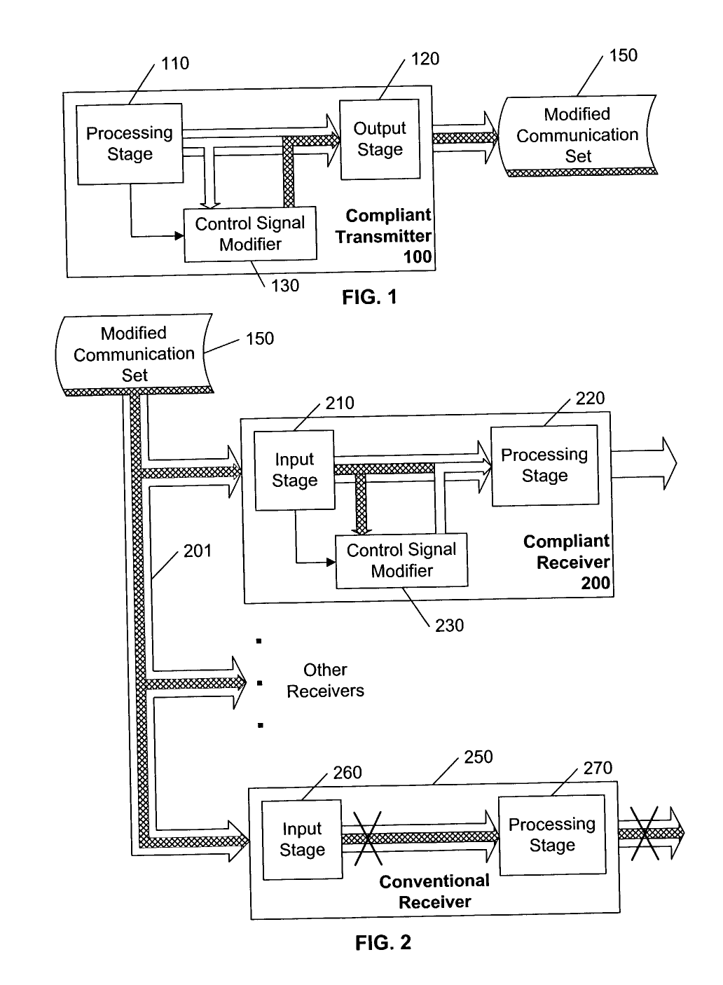

FIG. 1 illustrates an example block diagram of a copy-protection transmitter 100 in accordance with this invention. For ease of reference and understanding, the terms transmitter and receiver are used herein in the general sense, to identify devices that provide the protected content material as an output, and devices that accept the protected content material as an input, respectively.

The transmitter 100 includes a control-signal modifier 130 that is configured to modify one or more control signals associated with copy protected content material. Consistent with the referenced copending application, the transmitter 100 is configured to enable the control-signal modifier 130 whenever a copy-protection signal is detected in the original content material, or detected in signals associated with the original content material.

For ease of understanding, the transmitter 100 is illustrated as comprising a processing stage 110 and an output stage 120, between which the control signal is modified by the modifier 130. The specific partitioning between processing stage 110 and output stage 120 is dependent upon the selected control signals that are modified. For example, if the CRC error-detecting code of the content material is selected to be modified, the processing stage 110 includes all of the components required to produce the original CRC, and the output stage 120 includes the components that communicate the CRC without any further processing. In this manner, the output stage 120 is enabled to communicate the modified-CRC from the control-signal modifier 130. In like manner, if the selected control signal is a parity bit that is associated with individual data items within the content material, the output stage 120 includes the components that communicate the parity bit without further processing, while the processing stage includes the components that determine the original parity bit.

As illustrated by the hatched regions in the data flow arrows, the modifier 130 modifies the selected one or more signals associated with the protected content material, and the combination of the original content-material and the modified and unmodified control signals form a modified communication set 150. This set corresponds to the same information that a conventional transmitter would provide, except that one or more of the signals within the set have been modified by the modifier 130. That is, for example, if the transmitter 100 is a network-interface card, the content of the set 150 will correspond to the conventional output of a network-interface card, except that one or more signals are modified by the modifier 120.

FIG. 2 illustrates an example block diagram of a receiving system that includes a compliant copy-protection receiver 200 in accordance with this invention, as well as a conventional receiver 250. In this illustration, the communication path 201 illustrates the communication of the modified communication set 150 to a variety of receivers, either intentionally or unintentionally. That is, for example, a transmission on a local-network is accessible to any of the nodes on the network, even though the transmission may be targeted or addressed to a particular node on the network. Also in this illustration, the hatched regions in the data-flow arrows indicate the presence of modified control signals associated with the content material of the modified communication set 150.

In the compliant receiver 200, an input stage 210 recognizes that the received communication set 150 is copy-protected, and enables a control signal modifier 230 to “unmodify” the control signals in the modified communication set 150, thereby restoring these signals to their original and conventional state, for subsequent processing by a processing stage 220. The control signal modifier 230 performs the inverse function of the control signal modifier 130 in FIG. 1 to effect this “un-modification”.

As with the compliant transmitter 100, the segregation of functions in the receiver 200 between input stage 210 and processing stage 220 is dependent upon the particular signals that are modified in the modified communication set. If for example, the modified communication set is communicated in a modulated form, and a demodulation is required to distinguish the particular control codes, the input stage 210 will contain the required demodulator, and the processing stage 220 will contain the components that act upon the control codes.

In the conventional receiver 250, which is either purposely non-compliant or unaware of the copy-protection scheme of this invention, the input stage 260 does not detect the copy-protection signal, and does not initiate a removal of the modification to the control signals in the modified communication set 150. In a purposely non-compliant receiver 250, such as a wide-area network interface card that is designed in accordance with this invention, the receipt of the modified control signals explicitly effects a rejection of the received set 150, so that the protected content material is not propagated to the processing stage 270. In a receiver 250 that is virtually unaware of this copy protection scheme, it is expected that the processing of the modified communication set 150 will often result in the set 150 being rejected by the processing stage 270, as discussed further below.

Preferably, the control signals that are selected for modification are signals that can be expected to control the subsequent communication or processing of the content material by conventional communication or processing systems, such that, a modification of these signals is likely to inhibit the subsequent communication or processing by conventional systems and devices.

An error-detecting signal, such as a parity bit as used in a Vertical Redundancy Check (VRC), or a parity byte as used in a Longitudinal Redundancy Check (LRC), or a checksum as used in a Cyclic Redundancy Check (CRC), is often used by a receiving system to accept or reject received inputs signals as being valid or invalid, under the assumption that it is often preferred to reject data rather than to accept erroneous data. In a financial environment, for example, it is usually preferred to refuse to post a transaction rather than post a potentially erroneous transaction. In like manner, in the communication of video, it is often preferred to “freeze” on a prior image frame, by not accepting a received new frame, rather than displaying a distorted image frame. Thus, a modification to an error-detecting signal is one of the preferred controlled signals for modification.

An error-correcting signal is also particularly preferred for modification. If the processing of the error-correcting signal includes an error-detecting scheme that identifies uncorrectable errors, an error-correcting receiving system will generally reject the received material when an uncorrectable error is detected. If, on the other hand, the receiving system does not recognize the received message as containing too many errors to correct, the receiving system will apply the modified/erroneous error-correcting-code to the received content material. Because the error-correcting code is erroneous, applying it to the content material will produce erroneous content material, which, even if communicated to a wide-area network, will be significantly distorted. That is, by modifying an error-correcting signal, the received material will either be rejected or distorted by a non-compliant receiving system.

A synchronization control signal may also be used for modification, so that a non-compliant receiving system is unable to establish synchronization with the transmission of the modified communication set. However, using such a scheme, a compliant receiving system would need to be configured to synchronize with either the conventional synchronization signal or the modified synchronization signal while the message is being received, as compared to the aforementioned schemes, wherein a message will generally be received and stored in a buffer while the receiver decides whether to accept or reject the message.

The effects of a modification to other control-type signals associated with the communication of content material will be evident to one of ordinary skill in the art, and based on these effects, select other signals may be modified, in addition to, or in lieu of, the preferred signals disclosed herein.

The particular modification that is employed is somewhat arbitrary, requiring only that the modifier 230 in the receiver 200 be configured to effect a reversal of the modification that is performed by the modifier 130 in the transmitter 100. In the parity examples, above, a simple inversion of each parity bit or byte will generally be sufficient to hinder the propagation of the modified communication set 150 by a non-compliant device. In such a case, the modifiers 130 and 230 are equivalent, and merely invert the selected control bits or bytes. A more sophisticated modification includes an inversion of particular subsets of a set of control signals, using for example, an exclusive-or function with a key that identifies the subsets of inverted and non-inverted signals. For example, in a CRC system, each checksum byte may be exclusive-or'd with a key byte to produce a modified checksum byte. Again, because the exclusive-or function is symmetric, both the modifiers 130 and 230 will be equivalent, both applying the exclusive-or function between the checksum byte and the defined key byte.

Although the invention is presented using the paradigm of copy-protected content material, the principles of this invention may also be applied to other applications. For example, in a local-area network having one or more wide-area access devices, local security can be provided by using compliant receivers for each local network interface card, and purposely non-compliant receivers for each wide-area network interface card. In such an embodiment, each device on the network will be configured to modify the control codes of transmissions from each network node, except those that are specifically identified as being suitable for wide-area distribution (i.e. not protected).

The foregoing merely illustrates the principles of the invention. It will thus be appreciated that those skilled in the art will be able to devise various arrangements which, although not explicitly described or shown herein, embody the principles of the invention and are thus within its spirit and scope. For example, in the above description of the invention, the stages 110 and 210 determine whether or not to enable the modification of the control signals by the modifiers 130 and 230, respectively, based on the presence or absence of a copy-protect signal, or, alternatively, a wide-area-allowed signal. The receiver 200 might alternatively be configured to directly detect whether the control signals are modified, and automatically effect the un-modification. For example, if the receiver 200 detects an excessive number of parity errors, it may automatically invoke the modifier 230, to distinguish between erroneous material and copy-protected material. If the invocation of the modifier 230 substantially reduces the number of parity errors, the receiver 200 recognizes the material as copy-protected, and proceeds accordingly, in the same manner that it would have proceeded given an explicit copy-protection signal. These and other system configuration and optimization features will be evident to one of ordinary skill in the art in view of this disclosure, and are included within the scope of the following claims.

I claim:

1. A method for limiting distribution of content material, comprising:
providing one or more control signals that are associated with communication of the content material via conventional communication devices, and
modifying the one or more control signals so as to inhibit the communication of the content material via conventional communication devices.

2. The method of claim 1, further including
detecting a copy-protection signal associated with the content material, and wherein
modifying the one or more control signals is dependent upon detection of the copy-protection signal.

3. The method of claim 1, wherein
the content material is unencrypted.

4. The method of claim 1, wherein
the one or more control signals includes at least one of:
a parity signal,
a checksum signal, and
a synchronization signal.

5. A method for limiting distribution of content material, comprising:
receiving a communication that includes the content material and one or more first control signals that correspond to the content material, and
modifying the one or more first control signals to produce second control signals that facilitate subsequent processing of the content material.

6. The method of claim 5, further including
detecting a copy-protection signal associated with the content material, and wherein
modifying the one or more first control signals is dependent upon detection of the copy-protection signal.

7. The method of claim 5, wherein
the content material is unencrypted.

8. The method of claim 5, wherein
the one or more control signals includes at least one of:
a parity signal,
a checksum signal, and
a synchronization signal.

9. A copy-protection system comprising:
a receiving device that is configured to receive a communication of content material and associated control signals, and
a modifying device that is configured to modify one or more of the control signals to facilitate a subsequent processing of the content material.

10. The copy-protection system of claim 9, wherein
the content material is unencrypted.

11. The copy-protection system of claim 9, wherein
the receiving device includes a network interface.

12. The copy-protection system of claim 9, further including:
a transmission device that is configured to provide the communication of the content material and the associated control signals.

13. The copy-protection system of claim 12, wherein
the transmission device includes a network interface.

14. The copy-protection system of claim 9, wherein
the one or more control signals includes at least one of:
a parity signal,
a checksum signal, and
a synchronization signal.

15. A copy-protection system comprising:
a transmission device that is configured to provide a communication of content material and associated control signals, and
a modifying device that is configured to modify one or more of the control signals to inhibit a subsequent processing of the content material.

16. The copy-protection system of claim 15, wherein
the content material is unencrypted.

17. The copy-protection system of claim 15, wherein
the transmission device includes a network interface.

18. The copy-protection system of claim 15, wherein
the one or more control signals includes at least one of:
a parity signal,
a checksum signal, and
a synchronization signal.
